(19) United States
(12) Patent Application Publication
(10) Pub. No.: US 2026/0021533 A1
(43) Pub. Date: Jan. 22, 2026

(54) COMPUTER IMPLEMENTED METHOD FOR POWDER BED FUSION PROCESSES AND APPARATUS

(71) Applicant: Stratasys Powder Production Ltd., Nottingham (GB)

(72) Inventor: Gianluca Dorini, Nottingham (GB)

(21) Appl. No.: 19/252,726

(22) Filed: Jun. 27, 2025

(30) Foreign Application Priority Data
Jul. 21, 2024 (GB) 2410651.0

(51) Int. Cl. B22F 10/85; B22F 10/28; B22F 10/368; B33Y 10/00; B33Y 30/00; B33Y 50/02

(52) U.S. Cl. CPC B22F 10/85; B22F 10/28; B22F 10/368; B33Y 10/00; B33Y 30/00; B33Y 50/02

(57) ABSTRACT

A method of determining layer anomalies in a powder bed fusion process. The method includes obtaining measured pre-fuse temperatures and measured post-fuse temperatures for at least a subset of a plurality of layers of a build process; providing for each layer an estimated pre-fuse temperature; determining a temperature difference between the estimated and the measured pre-fuse temperature for each layer and generating a temperature difference data set; determining a level of deviation from the temperature difference data set; determining a layer anomaly in the fusion process if the level of deviation exceeds a predefined threshold; and upon determining an anomaly in one or more layers, generating a user alert and/or stopping the build process. A powder bed fusion apparatus comprising a processor configured to carry out the method is also provided.

### FIELD OF THE INVENTION

The present disclosure relates to the field of powder bed fusion and in particular to a computer-implemented method for monitoring and controlling the performance of powder bed fusion processes and apparatus.

### BACKGROUND

In powder bed fusion processes like print and fuse or laser sintering, an object is built up layer by layer from powder material by selectively fusing, or melting, the powder over successive object cross sections within each distributed layer. This results in an object supported within a bed of unfused powder that can be removed at the end of the process by brushing and/or blowing the supportive powder off by pressurised gas streams. Recently, improvements to powder bed fusion processes have led to high yield through fast layer times and increasing build bed size. While laser sintering processes typically are more time consuming due to having to trace the object cross section along a complex route, print and fuse processes employ scanning printheads and lamps that can process each layer in a single pass. The printheads deposit absorber that causes fusing radiation to be selectively absorbed by the powder with absorber and not by powder void of absorber.

Powder bed fusion processes require careful control over the temperature differentials across the layer. For example, the temperature difference between fused and non-fused powder needs to be sufficient to generate selectivity and ensure a clean object surface, while not being overly large to risk warping of the fused part. To some degree this may be addressed by controlling the temperature of each layer before the step of fusing, for example by a static and/or scanning infrared heater that preheats each newly deposited layer to a temperature within the operating window, which is a temperature range above the solidification temperature of the powder and below the melting point of the powder. There are multiple contributing factors that affect the temperature distribution over each layer. Improved methods are required for adequate process control, which will be addressed by the present invention disclosed herein.

### SUMMARY

The invention is set out in the appended independent claims, while particular embodiments of the invention are set out in the appended dependent claims.

### BRIEF DESCRIPTION OF THE DRAWINGS

Reference is now directed to the drawings, in which:

FIG. 1A is a flow chart of the computer-implemented method according to the invention;

FIG. 1B is a flow chart of a build process generating input to the method of FIG. 1A;

FIG. 2 is a schematic cross section side view through a build bed of a powder bed fusion apparatus configured to carry out the method of FIG. 1B and optionally of FIG. 1A;

FIG. 3 illustrates further detail of the build bed of FIG. 2;

FIG. 4 is a graph of measured post-fuse temperatures and measured and estimated pre-fuse temperatures over a number of layers;

FIG. 5 is an enlarged version of the lower curves of FIG. 4;

FIG. 6 illustrates a temperature difference data set for a nominal build process B0;

FIGS. 7-9 illustrate temperature difference data sets for three further build processes B1-B2;

FIG. 10 illustrates a variant of the flowchart of FIG. 1A; and

FIGS. 11A-11C are thermal images analysed as part of a verification routine of FIG. 10.

In the drawings, like elements are indicated by like reference numerals throughout. It should be noted that the drawings are not to scale and that certain features may be exaggerated in size to be more clearly visible.

### DETAILED DESCRIPTION

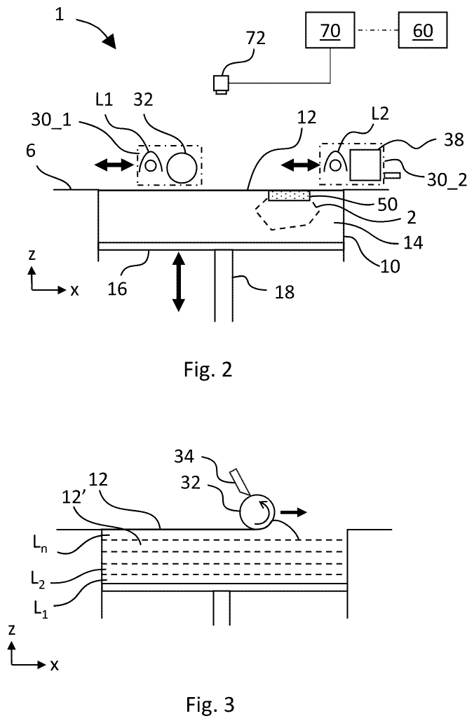

Powder bed fusion apparatus comprises hardware subsystems arranged to spread each layer over a build platform and to process each layer to define and fuse successive cross sections of an object. Such hardware is illustrated in FIG. 2, which is a schematic cross section front view through a “print and fuse” apparatus 1. A build platform 16 supports the build volume 14 that is formed from successive layers of build material and is laterally contained within container walls 10. The uppermost surface of the build area 14 is the build area 12. The build platform is supported by a lifting device 18 arranged to vertically lower or lift the build platform 16 within the container walls 10, as indicated by the solid vertical arrow. The lifting device may for example be a piston comprising a spindle and a stepper motor. A distribution device 32, herein illustrated by example in the form of a roller, is mounted to a first carriage 30-1 that is arranged to move over the work surface 6 comprising the build area 12. The distribution device may alternatively be a blade pushing powder ahead of it, or a hopper with a levelling edge that progressively drops build material into the recess and levels it as it moves over the recess. To form a new layer, the build platform 16 is lowered to form a recess in the work surface 6. The depth of the recess defines the thickness of the new layer. The distribution device 32 pushes a supply of build material ahead of it over the build platform to fill the recess. This is shown in more detail in FIG. 3, which illustrates the formation of a new layer Ln over a sequence of previous layers L1, L2, . . . on the build platform 16 of FIG. 2, where the layer number is denoted by Lₙ. The uppermost layer Ln will form the new build bed surface 12 over the previous build bed surface 12′ and is flush with the work surface 6. In this variant, the distribution device is a roller 32 and a scraper 34 arranged to clean the surface of the roller of any build material as it rotates in a counter-rotating motion during its pass from left to right (in direction of the solid arrow) over the recess.

Returning to FIG. 2, mounted on the first carriage 30_1 behind the distribution device 32 may be a warming lamp L1 that preheats the freshly distributed layer close to or to a target bed temperature that lies within a sintering window. The sintering window is between the solidification temperature (optionally the onset of the solidification temperature) and the melting temperature (and/or optionally the onset of the melting temperature) of the build material. Next, to define an object cross section 50, absorber is deposited by a printing module 38, mounted for example to a second carriage 30_2. After this, fusing radiation is applied to the layer by a fusing lamp L2, here shown mounted behind the printing module 38, to selectively fuse the build material within the defined cross section 50. The radiation spectrum of the fusing heat source and the absorption of the absorber are chosen with respect to the absorption spectrum of the build material so that the fusing radiation emitted by the fusing heat source L2 is strongly absorbed only by the absorber and, by comparison, not by the build material outside the cross section 50 void of absorber. In this way, the fusing radiation only significantly raises the temperature of the build material within the cross section, and to a level that causes melting and fusion.

Typically the warming and fusing steps are provided by heat sources that travel over the layer, a warming heat source following the distribution device to warm the new layer and a fusing heat source following the absorber deposition device. In addition, a stationary overhead heater array is typically operated to maintain the temperature of the layer surface at the target bed temperature. The stationary overhead heater is typically feedback controlled based on thermal measurements made by a sensor 72 configured to monitor the temperature distribution of each layer. Furthermore the stationary overhead heater typically comprises individually controllable heater elements that provide zonal heating at relatively low resolution to each layer compared to that provided by the absorber deposition device. The apparatus comprises a controller to control the hardware subsystems of the apparatus, and is connected or connectable (as indicated by the dashed line) to a processor 60 configured to process data on behalf of the controller 70. The processor 60 may be arranged to receive or retrieve the measurements by the thermal sensor 72, perform an analysis of the measurements, and provide an output to the controller to cause the controller to apply temperature feedback control to the overhead heater.

Control over the thermal process is important in powder bed fusion processes to ensure the required level of melting within each cross section and between successive cross sections is achieved to ensure that part properties are consistent and high mechanical and visual quality can be reliably achieved. In addition, the temperature of the surrounding powder needs to be tightly controlled to avoid deformations in the part. Significant departures from the target bed temperature can lead to poor mechanical adhesion between cross sections in the case of a significantly lower temperature, leading to poor mechanical strength of the object. A significantly higher temperature may compromise the intended dimensional accuracy. Different events or failures in the apparatus subsystems can cause departures from the required part properties. Adequate functioning of the subsystems that contribute to the temperature uniformity and thickness of each layer is necessary to ensure consistent quality of the formed object 2.

It may for example be typically assumed that a consistent layer thickness is distributed, and the heat sources are controlled based on this assumption. A lack of control over layer thickness as a result of defective behaviour of hardware or other events affecting layer thickness can therefore be expected to lead to poor thermal control that may lead to deterioration in part properties. Affected parts usually present weak mechanical strength in the layering direction (“z-strength”) and/or aesthetics flaws which are often only revealed after the build process is complete and parts have been unpacked and assessed. The physical cause of abnormal, compromised part quality is often difficult to predict or to identify quickly, typically requiring iterative tests to exclude well-functioning components from defective ones. Improved detection and/or prediction methods are required for early detection and/or preventive maintenance to improve throughput and yield.

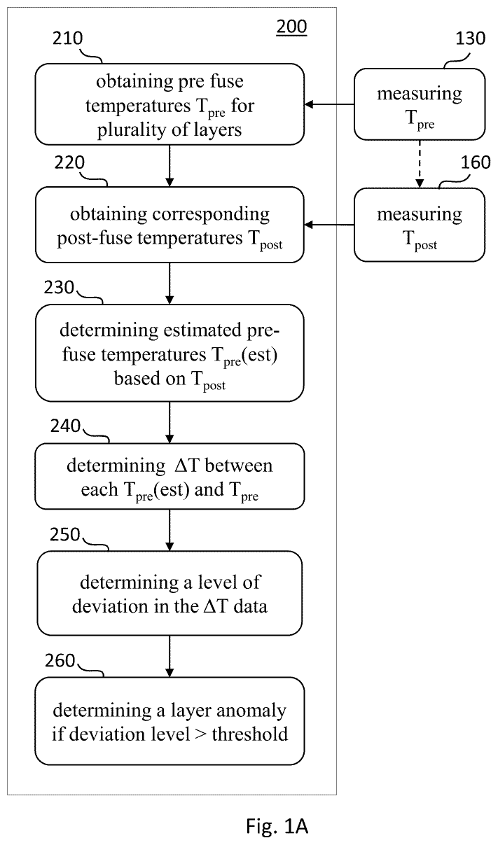

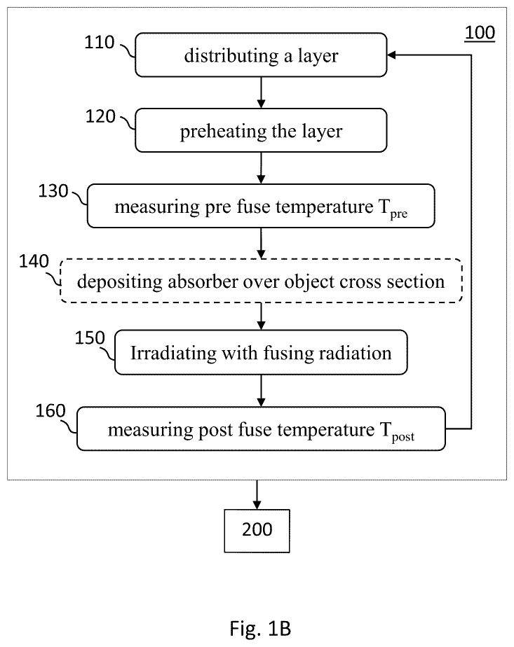

The inventor has developed a computer-implemented method for determining anomalies based on temperature measurements of the distributed layers as will now be described in detail with reference to FIGS. 1A-11C. Turning first to FIG. 1A, which is a flowchart of the computer-implemented method 200 according to the invention, and with reference to FIG. 1B, which is a flow chart of a build process 100 generating temperature measurements as input for the method according to the invention, the method comprises obtaining from the build process 100 thermal measurements and analysing the thermal measurements to determine layer anomalies. The build process 100 comprises, with reference to FIG. 1B:

At block 110, distributing a layer by a distribution device 32 passing over the uppermost surface of the build platform 16 to form a new layer;

At block 120, warming or preheating the distributed layer by irradiating it with warming, non-fusing radiation, for example by passing a preheat lamp L1 over the layer following the distribution device so as to preheat the layer to within a sintering window;

At block 130, measuring a pre-fuse temperature T_{pre-fuse} (abbreviated to “Tₚᵣₑ” in FIGS. 1A and 1B), for example from temperature measurements of the layer taken by the thermal camera 72 arranged above the build platform 16 and configured to monitor the temperature distribution of each layer. The measured temperature T_{pre-fuse} may be stored as an average temperature of the layer;

At optional block 140, depositing an absorber to define a cross section of the object, for example by passing a printing module 38 depositing absorber fluid to define an object cross section 50. This step is optional since anomalies may also be detected for layers that did not receive absorber fluid, and/or comprise a fused object cross section. In addition, the analysis routine also is applicable to laser sintering in which absorber is not typically deposited;

At block 150, irradiating the layer with fusing radiation, for example by passing a fusing lamp L2 over the layer following the distribution device 32 to selectively sinter, melt and fuse the build material within the cross section 50, or optionally by tracing with a laser the build material to form a cross section that is selectively sintered, melted and fused;

At block 160, measuring a post-fuse temperature T_{post-fuse} (abbreviated to “Tₚₒₛₜ” in FIGS. 1A and 1B), from for example temperature measurements of the layer by the thermal camera 72. The measured temperature may be stored as an average post-fuse temperature of the layer.

Blocks 110 to 160 are repeated for at least a subset of the plurality of layers required to form the object 2. Unless the build process is discontinued early due to detected anomalies, these blocks may be repeated until the object 2 is formed. Typically, before the object is formed, a warming subset of layers is deposited that form a warm support for the object to be formed. The method may be initiated at the beginning of the warming subset. In the case of a print and fuse process, non-object layers not comprising an object cross section may nonetheless be heated by both preheat and fusing sources without absorber being deposited.

Concurrently or subsequently to the build process 100, the measured pre-fuse and post-fuse temperatures are provided to the computer-implemented method 200, which comprises, with reference to FIG. 1A:

At block 210, obtaining the measured pre-fuse temperature T_{pre-fuse} for at least a subset of the plurality of layers of the build process, optionally for all layers of the build process;

At block 220, obtaining the measured post-fuse temperature T_{post-fuse} for the subset or for all layers of the build process;

At block 230, providing, for each layer of the subset or of the entire plurality of layers of the build process, an estimated pre-fuse temperature T_{pre-fuse}(est) (abbreviated to “Tₚᵣₑ(est)” in FIG. 1A) based on a corresponding post fuse temperature. The corresponding post-fuse temperature T_{post-fuse} may be the average measured post-fuse temperature of the preceding layer of the layer for which the estimated pre-fuse temperature T_{pre-fuse}(est) is provided. Providing the estimated pre-fuse temperatures may comprise determining by calculating the estimated pre-fuse temperature T_{pre-fuse}(est) from the average post-fuse temperature based on a conversion model. The conversion model may be predetermined as a best fit average based on the measured pre-fuse temperatures and the measured post fuse temperatures of a preceding subset of layers of the plurality of layers of the build process, from an initial or warming subset of layers of the plurality of layers of the build process, or from multiple layers of a nominal, healthy build process. The conversion model may be a scalar conversion of a corresponding average post-fuse temperature to calculate the estimated average pre-fuse temperature of a given layer.

At block 240, a temperature difference ΔT between each estimated and obtained pre-fuse temperature is determined to arrive at a temperature difference data set ΔT(Lₙ) for the subset or for the plurality of layers.

At block 250, a level of deviation is determined for the temperature difference data set ΔT(Lₙ). The level of deviation may comprise the level of noise in the temperature difference data set, for example the standard deviation, the average absolute deviation or the median absolute deviation. The level of noise may be progressively determined for a moving window of a given number of layers. Additionally or instead, the level of deviation may comprise one or more outliers that have been determined to be statistically different to the distribution of the temperature difference data set.

At block 260, a layer anomaly is determined if the level of deviation exceeds a predetermined threshold or value.

Optionally, based on predefined criteria regarding the determined layer anomalies, the method may comprise causing a user alert to be generated highlighting the detection of layer anomalies and thus a potentially compromised object, and/or causing the build process to be paused or stopped.

The one or more outliers may be determined by applying a standard likelihood analysis method to characterize the temperature difference data set ΔT(Lₙ). The likelihood analysis may be used to statistically identify outliers as those falling within the extreme percentiles of the distribution of the temperature difference data or outside a predefined temperature range. The predefined temperature range may be defined from prediction intervals, which are the intervals in which the temperature difference is expected to fall within according to a specified level of probability. Such probability may be set for 95%. The one or more determined outliers may be used to identify one or more layer anomalies and may signify rare events as will now be described and which may require investigations as to their cause.

Each outlier may signify either a “cold layer”, where the outlier falls below the predefined temperature range and signifies that the corresponding layer is colder than estimated, or a “hot layer”, where the outlier lies above the predefined temperature range and signifies that the corresponding layer is hotter than estimated. The user alert may be generated and/or the build process may be stopped upon determining that at least one outlier, for example at least one cold layer. Alternatively, the method may comprise monitoring the number of outliers determined and only generating an alert and/or stopping the build process if the number of outliers exceeds a predefined number of outliers. Optionally, the predefined number of maximum permissible outliers may be restricted further to fall within a group of a predefined number of successive layers. The relevant outliers that trigger the alert and/or discontinuation of the build process may be cold layers. Optionally, the alert and/or the stopping of the build process may only be triggered if the one or more layer anomalies, which may be one or more hot and/or cold layers, are identified for object layers (layers comprising a selectively fused object cross section). Where one or more anomalies are identified for non-object layers, and not for object layers, the method may comprise continuing the build process.

The obtained pre-fuse temperature T_{pre-fuse} may be an average pre-fuse temperature determined from a plurality of pre-fuse temperature measurements of the layer, wherein the obtained post-fuse temperature T_{post-fuse} may be an average post-fuse temperature determined from a plurality of post-fuse temperature measurements of the layer, and wherein the estimated pre-fuse temperature T_{pre-fuse}(est) is an estimated average pre-fuse temperature estimated based on the average post-fuse temperature for each layer. The respective averages may be calculated from the temperature distribution measured of the layer by the thermal camera. The averages may be determined from the obtained temperatures as part of block 210 and block 220 of the method 200, where the obtained temperatures are temperature distributions, based on thermal images by the thermal camera, for example. Obtaining the average pre-fuse temperature may comprise measuring or obtaining a plurality of pre-fuse temperature measurements of the layer between preheating and fusing (for example based on thermal camera images), and calculating the average pre-fuse temperature from the plurality of pre-fuse temperature measurements; and wherein obtaining the average post-fuse temperature comprises measuring or obtaining a plurality of post-fuse temperature measurements of the layer between fusing and distributing (for example based on thermal camera images), and calculating the average post-fuse temperature from the plurality of post-fuse temperature measurements.

The obtained temperatures may be pre-calculated average pre-fuse temperature and the average post-fuse temperature at block 210 and 220, and may have been calculated and stored as part of the data recording protocol during the build process.

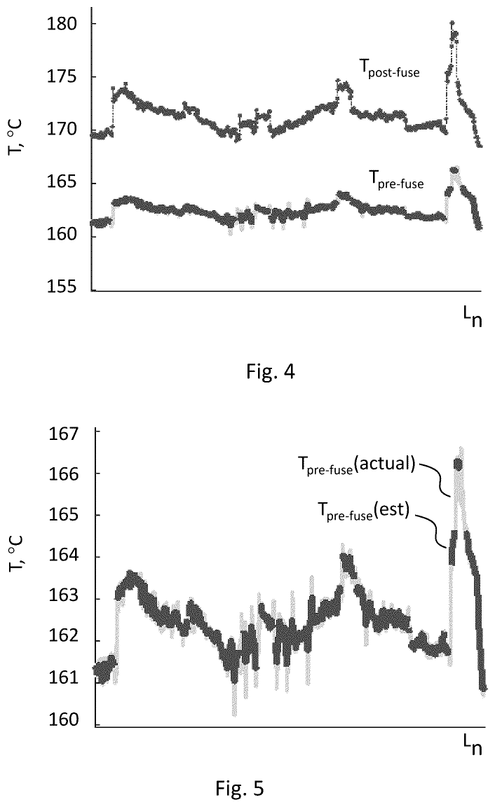

FIG. 4 is a graph illustrating an example of the average temperature determined for a sequence of layers Lₙ of: the average post-fuse temperatures T_{post-fuse} for each layer, as may be determined from the measurements at block 150 of FIG. 1B (upper graph, dark grey), and the corresponding average pre-fuse temperatures T_{pre-fuse} (lower graph, light grey) as may be determined from the measurements at block 130 of FIG. 1B and the estimated pre-fuse temperatures T_{pre-fuse}(est) (lower graph, dark grey) determined at block 230 of FIG. 1A. The layer of number n is denoted by Lₙ. It can be seen how the estimated pre-fuse temperatures T_{pre-fuse}(est), estimated based on the model conversion of the determined average post-fuse temperatures, closely correspond to the measured average pre-fuse temperatures T_{pre-fuse} in this case. A close-up of the lower two graphs is shown in FIG. 5.

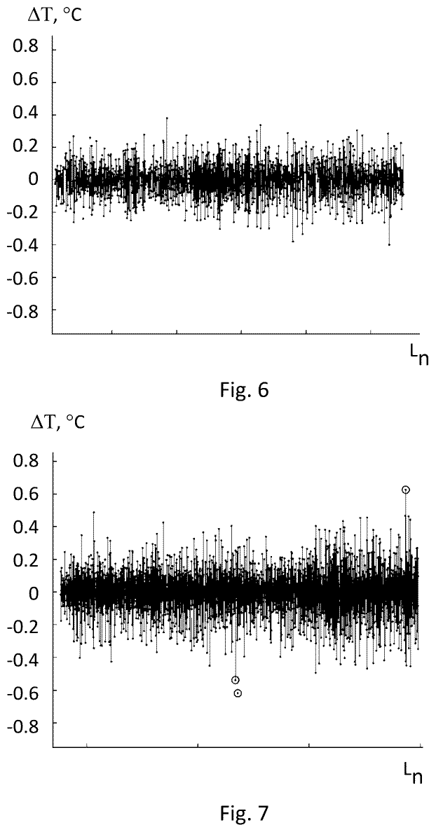

From the two graphs of FIG. 5, the temperature difference data set ΔT(Lₙ) is determined at block 240 of FIG. 1A, by subtracting each actual, measured pre-fuse temperature T_{pre-fuse}(actual) from each estimated pre-fuse temperature T_{pre-fuse}(est) for each layer Lₙ. From the temperature difference data set ΔT(Lₙ), layer anomalies may be determined by analysing the level of noise for deviations, as will now be explained with reference to FIGS. 6 to 9. Each of these Figures shows a temperature difference data set ΔT(Lₙ) obtained over a number of layers Lₙ from different build processes and/or apparatus.

FIG. 6 illustrates an example temperature difference data set ΔT(Lₙ) from a nominal, healthy build process B0. FIG. 6 may result by subtracting the two closely corresponding graphs in FIG. 5 from one another; i.e. FIGS. 4 and 5 may represent thermal data obtained from a healthy, nominal build process. From the distribution of the temperature difference data set ΔT(Lₙ), a level of noise, for example the standard deviation, may be calculated. In the case of FIG. 6 the temperature difference data set may represent the nominal noise level, e.g. the nominal standard deviation. For this “healthy” build process, the standard deviation of temperature differences between measured and estimated pre-fuse thermal temperatures is 0.02° C. and no outliers are indicated.

In FIGS. 7 to 9, temperature difference data is shown for three further build processes B1-B3 and for which layer anomalies were identified as determined by the standard deviation and by a likelihood analysis to determine outliers.

For build process B1, the temperature difference data set ΔT(Lₙ) is shown in FIG. 7, and has a standard deviation of 0.08° C. The noise level is overall higher than that of the healthy build process represented by FIG. 6. This relatively higher standard deviation may be due to a fault or misfunction with the powder distribution module, for example due to damage or debris on the roller and/or scraper. Hardware inspection or maintenance may be necessary.

A statistical analysis of the temperature difference data set ΔT(Lₙ) further identifies three anomalies in the form of outliers (circled). Two outliers are marked to one side of the distribution and signify “cold” layers. These cold layers exhibit an average temperature that lies statistically below a predefined temperature difference range. A further, single outlier is marked to the other side of the distribution, and signifies a “hot” layer. A hot layer exhibits an average temperature that lies statistically above the predefined temperature difference range. This relatively low incidence of hot and cold layers may be triggered by desynchronisation between the vertical movements of the build platform and the distribution module's horizontal movements. An alert in this case may request the user to inspect the software or firmware for errors.

In FIG. 8, for build process B2, the calculated overall standard deviation in the temperature difference data set ΔT(Lₙ) is 0.19° C. The level of noise is initially similar to that in FIG. 7 but progressively increases with layer number as the build progresses. Hot and cold layers are identified from about mid-way and onwards. The gradual increase in noise in the temperature difference data set for this build process indicates a progressive failure of a component and that inspection of the hardware of the apparatus and/or the measured thermal maps is required. Such failure may be due to debris along the build platform vertical path, making vertical movement of the build platform within the container walls grippy and irregular, and requires cleaning of the container inner walls and/or the platform seal sealing the platform against the inner walls.

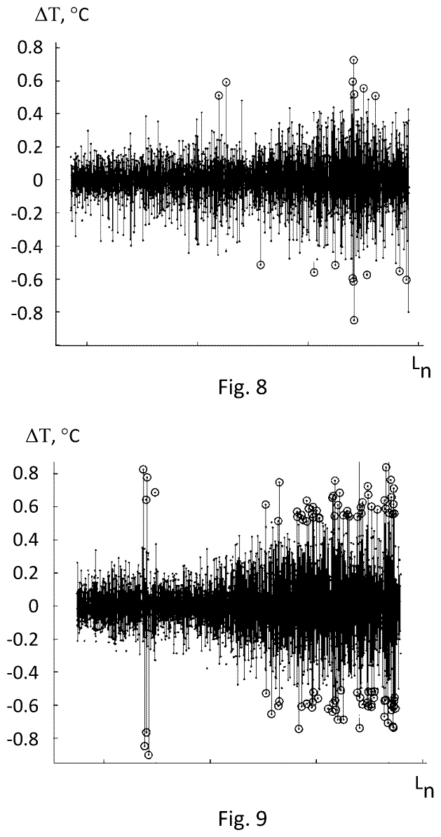

In FIG. 9, for build process B3, the calculated standard deviation of the temperature difference data set ΔT(Lₙ) is 0.25° C. The level of noise begins at a level similar to that in FIG. 7 but increases significantly about mid-way through the build process. In addition, outliers are identified over a short period in the first part of the build process that suggest both hot and cold layers. The instance of hot and cold layers in the second part of the build process increases and continues at high frequency throughout the second part. The temperature difference data for this build process may highlight that further inspection of the hardware of the apparatus and/or the measured thermal images is required to allow resolving the issue so that a future build process results in objects at the required mechanical and/or aesthetic quality. The high frequency of hot and cold layers towards the second half of the build may indicate fatigue experienced by the motor moving the build platform as the weight of the build gets progressively heavier. This may require motor inspection and/or replacement.

Anomalous behaviour in the temperature difference data set ΔT(Lₙ) may thus be interpreted according to the following, non-exhaustive examples. The processor 60 may be provided with a look-up table of fault indicators against a type and/or level of layer anomaly, and configured to compare the type and/or level of the determined layer anomaly against the look-up table to cause a specific user alert to be generated. The specific alert may provide the user with a shortlist of probable system faults. The fault indicator may cause the processor 60 to carry out a verification routine as will be described below, before causing an alert to be generated or causing the build process to be stopped.

The cause of a cold or hot layer may be due to a discontinuity or step change in the actual layer thickness distributed compared to previous and subsequent layers. Where a spindle is used as a lift mechanism, a defect of the spindle may be the cause. An increased noise level (e.g. an increased standard deviation) may be attributed to anomalies in the distribution sub-systems, for example to a faulty roller and/or scraper movement, or to irregular vertical movement of the build platform 16. This may cause an excessive non-uniformity in the distributed layer thickness. Where a cleaning device 34 is used to clean the surface of the distribution device, the level of noise may vary depending on the wear and tear and thus the effectiveness of the cleaning device. This can cause the build material to adhere to the roller surface and lead to uneven distribution of the layer, in the form of grooves, depressions and/or bumps. The cleaning device may be the scraper 34 of FIG. 3, or a brush or wiping device that is configured to clean the surface of the roller. In variants of the apparatus, the cleaning device may be contactable upon a command of the controller, or upon the completion of each layer. In variants, the cleaning device may travel with the roller and is arranged to remain in constant contact with the roller surface.

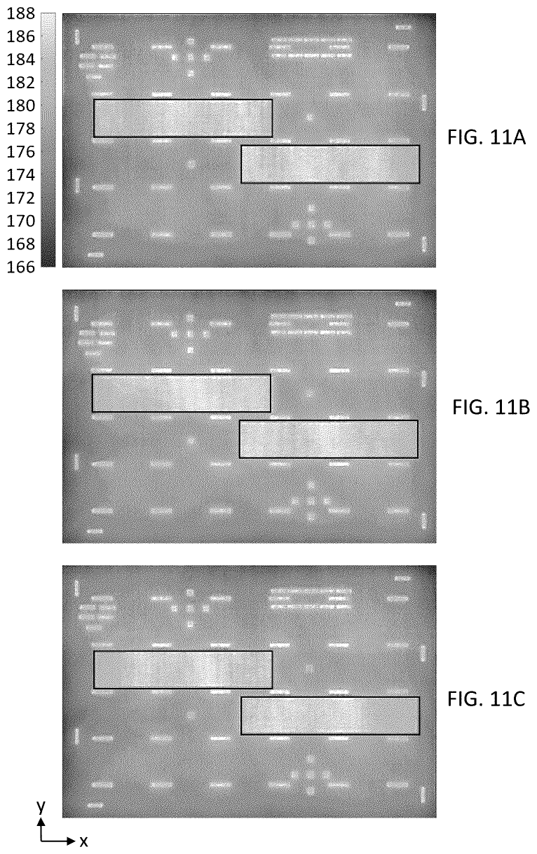

Based on the analysis of the temperature difference data set ΔT(Lₙ) of FIG. 8 for example, a further, detailed analysis of the thermal images measured during the build process may be necessary to identify unexpected hot or cold areas that do not correspond to what may be expected based on the slice data of that layer. This may be done by visual inspection of the thermal measurements for adjacent layers, from which roller issues may be determined as will now be described with reference to the thermal images of FIGS. 11A-C. Each image is an x-y array of temperatures, for example an array of 350×550 pixels, measured by the thermal camera 72. The three measured thermal images are the pre-fuse thermal images from three successive layers, and following the preheating of each layer, object cross sections 50 were defined by absorber and fused by fusing radiation. This means that each new layer is not only heated in the pre-heating step, but also by the underlying layer. The fused cross sections of a previous layer are thus clearly detectable to the thermal camera as areas heated by the fused cross section shapes underneath. These buried fused shapes are the “light” shapes, such as the two larger rectangular shapes specifically identified by the added black frames. The area surrounding the shapes is not overlying a fused shape and appears relatively colder (darker). The temperature distribution may range within the illustrative scale shown from 168 to 188 degrees.

In a healthy build process B0, the framed areas are expected to be of substantially the same shade, within for example no more than 0.5° C. In the thermal images of FIG. 11A-11C however, a pattern of banding can be detected, which is most easily seen in the framed areas: darker bands run across each light shape. It can be seen that the location of the bands changes from one image to the next rather than remaining in the same position. This suggests that the roller surface may not be clean but has powder adhering to it, causing a shifting banding pattern from one image to the next.

Preferably, this type of analysis is carried out by the processor 60, as will now be described.

### Automated Verification Routines

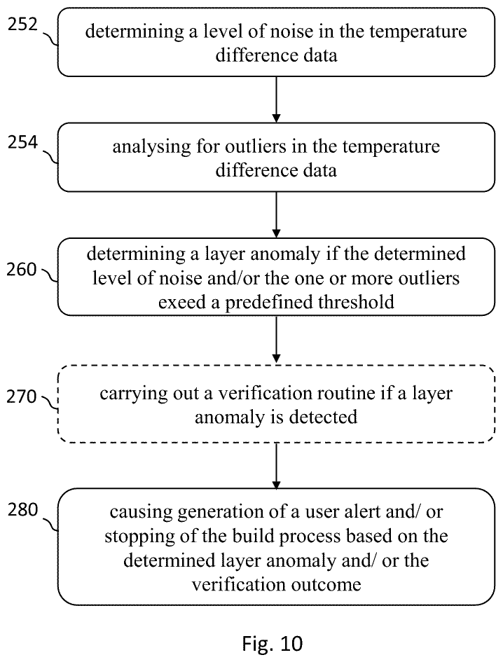

A variant of the analysis routine 200 and its output, as may be carried out by the processor 60 upon request by the controller 70, is illustrated in FIG. 10.

Block 250 of FIG. 1 may comprise at least one of: a block 252 of determining, for the subset or for the entire plurality of layers of the build process, a level of noise in the temperature difference data; and a block 254 of analysing for outliers outside the level of noise. Determining the noise level may comprise determining an average moving noise level over a number of successive layers of the temperature difference data set ΔT(Lₙ), and generating the user alert and/or stopping the build process upon detecting that the noise level increased by more than a maximum noise level change, e.g. >5% change in for example the standard distribution. The moving window may comprise for example 10, 20, or 30 layers or more. The number of layers may typically depend on the requirements of the process output and the system to be meaningful.

At block 260, a layer anomaly is determined if the determined level of deviation exceeds a predefined threshold. The predefined threshold against which the determined noise level may be compared may be based on, or comprise: an initial level of noise determined for an initial subset of multiple layers preceding the subset of layers or formed at the start of the build process; or the nominal level of noise as obtained from a nominal, healthy build process (such as shown in FIG. 6). The method may further comprise comparing the determined noise level to the initial or nominal noise level and generating a user alert and/or stopping the build process if the determined noise level exceeds the initial or nominal noise level. The predefined threshold may for example be an excessive amount, for example 5% or more, above the initial or nominal noise level, for example above the initial or nominal standard deviation in the temperature difference data. The determined level of deviation at block 260 may comprise at least one of the determined level of noise, a determined change in the level of noise and/or one or more outliers. Determination of the level of deviation may comprise comparing or analysing the temperature difference data sets of multiple layers in the subset of the plurality of layers over which the object is formed, or over several moving subsets within the plurality of layers. The predefined threshold for the level of deviation may comprise one or more of: a maximum noise level; a maximum change from the initial noise level as determined from, e.g., a warm up subset of layers; a type of the one or more layer anomalies determined, for example the type of outlier (hot or cold layer); a maximum permissible number of outliers over a certain number of successive layers, the subset of layers, or the moving window; or any other threshold relevant to the likely failure of the build process as may be determined based on the level of deviation.

At block 280, the processor 60 causes an alert to be generated and/or the build process to be stopped if the determined noise level and/or the number determined layer anomalies exceed the predefined threshold.

Preferably, at optional block 270 indicated in dashed outline, an additional verification or investigation routine is carried out by the processor, based on the determined layer anomaly. The method may therefore further comprise carrying out one or more verification and/or investigation routines to narrow down or verify the cause of the detected one or more layer anomalies so as to generate a shortlist of specific mitigating action and/or to provide a refined alert that points the user to a shortlist of possible causes that ought to be investigated during machine maintenance. The mitigating action may comprise an intermediate maintenance routine initiated by the controller based on the output by the processor 60 at block 270, and during which the build process may be paused.

The steps of the routine 200 may be carried out, based on a request by the controller 70, by a processor configured to execute the computer-implemented method 200 and any of its variants disclosed herein. The processor 60 may be comprised within the apparatus 1, or located remote from the apparatus and connectable to the controller 70 via a remote link or a wired or wireless network. The processor may be configured to obtain the measured pre-fuse and post-fuse temperatures and/or recorded build process data to carry out further verification routines at block 270, and to provide the output at block 280 to the controller to cause the alert and/or the stop command to be generated. The processor 60 may be part of the controller 70. The controller may control the apparatus and/or generate the alert based on the output of the executed method 200 as received from the processor. The alert may be displayed by a user interface of the apparatus, be provided as part of a build process report, and/or be flagged by causing an alert beacon to light up.

When the determined level of noise exceeds the predefined threshold, the processor may cause the issue of, and the controller 70 may issue, a user alert that allows the user to make a decision as to whether or not to continue the build process. In variants, the output by the processor 60 may be configured to cause the build process to be stopped when it becomes likely that resulting objects would not meet the required quality, for example when an unexpected high level of noise and/or an unexpectedly high frequency and/or sequence of outliers is detected. In addition, or instead, the type of outlier, such as a cold layer, and its frequency over a certain number of layers may cause the processor to generate an instruction that causes the controller 70 to stop the build process. The user alert may comprise a request to initiate investigations into the distribution sub-system. Preferably, one or more automated mitigation routines, such as an automated maintenance routine, may be caused to be instructed by the controller for a hardware component identified as likely cause for the detected layer anomalies.

The temperature difference data set ΔT(Lₙ) can also be calculated any time after the build process is complete, as an analysis tool to improve the understanding in machine behaviour and allowing informed investigations when a machine displays unusual behaviour in the layering process. Furthermore, the method may allow comparing performance over a fleet of equivalent apparatus to identify specific apparatus operating below the average expected performance or which is drifting below the average over time. In this way, issues may be identified early, and preventive action may be taken.

At block 270, in more detail, the processor may be configured to, and/or the controller 70 may cause the processor to:

(a) upon detecting one or more layer anomalies in the form of excessive noise level(s), obtaining thermal images measured by the thermal sensor 72 for a group of adjacent layers comprising the layer for which the anomaly was determined. The images may be retrieved from a storage location for build process data recorded during the build process. The processor may further be configured to perform an image analysis of the retrieved thermal images, which may comprise comparing one image the next, and to identify unexpected variations in the thermal data. Such analysis may comprise:

(a1) determining an extent of a deviating sub-area within the layer over which unexpected temperature variations are identified. The threshold may comprise a predefined number of adjacent pixels or a predefined maximum percent extent of the image. Based on the extent of the deviating sub-area being smaller than the entire layer area for successive layers, causing the build process to be stopped and causing an alert or a command to be generated that the distribution sub-system (e.g. the roller or blade surface) is to be cleaned, optionally causing the distribution sub-system to be cleaned and optionally causing the build process to be resumed.

(a2) based on the extent of the deviating sub-area being substantially the entire layer area between successive layers, causing the build process to be stopped and causing an alert to be generated that the platform vertical lift sub-system (e.g. the motor) may not operate correctly and requires investigations;

(b) upon detecting one or more layer anomalies in the form of one or more outliers, obtaining and analysing recorded platform lift sub-system data (e.g. motor encoder data) relating to the vertical build platform movement for a group of adjacent layers comprising the layer for which the anomaly was determined, and comparing the recorded sub-system data to expected sub-system data; and upon determining that the obtained sub-system data deviates from expected sub-system data, to stop the build process and generate an alert that the platform lift sub-system may not be operating correctly and requires investigations. This sub-routine may also be carried out as part of (a2) to verify whether the vertical lift sub-system appears to be functioning abnormally, which could be an indication that the motor mechanism is the cause rather than any contamination adhering to the inner container walls and/or the platform seal.

Upon determining an unexpectedly high level of noise based on the standard deviation in the temperature difference data set, the processor may carry out a verification routine before causing the controller 70 to generate an alert and/or to stop the build process. The processor may obtain the measured pre-fuse thermal images of some or all of the layers for which an excessive noise level was determined. An example of a verification routine may be an automated image analysis. As described earlier, in the thermal images of FIG. 11A-C, a pattern of bands can be detected. The processor may, by performing image analysis, determine the locations of the bands in each image and compare the determined location of the pattern bands from one image to the next. If the location changes, as can be seen in these images by a shift in the banding from one image to the next, the processor may determine that the cause of the high level of noise is likely a problem with the distribution sub-system. The distribution sub-system may comprise a roller. If the roller surface has powder adhering to it, generally the output is a variation in layer thickness across each layer with a pattern that shifts from one layer to the next. The processor may cause the build process to be stopped and an alert to be generated that recommends an automated roller cleaning routine and/or recommends roller or cleaning device maintenance. Preferably, the output from the processor causes the controller to pause the build process, initiate a cleaning routine (for example where the cleaning device does not travel with the roller but is arranged off to one side of the build area), and to resume the build process once the cleaning routine is completed.

The determination of the temperature difference data sets ΔT(Lₙ) may be carried out dynamically during a build process to flag issues before the build process is complete. This allows stopping the build process and avoiding unnecessary waste in time and materials. When carried out during the powder bed fusion process, the determination is based on more than one layer, and the user alert and/or the stopping of the build process is based on determining one or more layer anomalies over a subset of multiple successive layers of the plurality of layers. The subset may be formed of a moving window of multiple layers of predefined, fixed number, for example 10, 20, 30 layers or more, to allow meaningful comparison. The size of the moving window is chosen to suit the rigor of the protocol applied to arrive at a meaningful alert, as the skilled person will be able to determine for the apparatus, process and the required level of control over object quality. The analysis routine 200 may be carried out continuously or over intermittent time intervals or intermittent groups or subsets of layers within the plurality or the total number of layers.

The obtained temperature is preferably an average temperature determined from a temperature distribution measured for a layer. The temperature may be measured as one or more single points within the layer, by a pyrometer, or by a thermal camera configured to detect high resolution thermal images. From the measurements or from the images an average temperature may be determined. The average temperature may be calculated from a thermal image as part of the method, or it may be provided as a pre-calculated average.

1. A computer-implemented method of determining layer anomalies in a powder bed fusion process, wherein a build process to form a three-dimensional object comprises a layer sequence of distributing a layer, preheating the layer, measuring a pre-fuse temperature of the layer, applying fusing energy to the layer, optionally to selectively fuse an object cross section within the layer, measuring a post-fuse temperature of the layer, and repeating the layer sequence for at least a subset of a plurality of layers over which the object is to be formed, the method comprising:
obtaining the measured pre-fuse temperatures and the measured post-fuse temperatures for at least the subset of the plurality of layers;
providing for each layer an estimated pre-fuse temperature based on a corresponding measured post-fuse temperature;
determining a temperature difference between the estimated pre-fuse temperature and the measured pre-fuse temperature for each layer to generate a temperature difference data set;
determining a level of deviation from the temperature difference data set;
determining one or more layer anomalies if the level of deviation exceeds a predefined threshold; and
upon determining one or more layer anomalies, causing a user alert to be generated and/or causing the build process to be stopped.

2. The computer-implemented method of claim 1 applied during the powder bed fusion process, wherein causing the user alert to be generated and/or the build process to be stopped is based on the subset of multiple successive layers of the plurality of layers.

3. The computer-implemented method of claim 1, wherein determining the level of deviation comprises determining a noise level of the temperature difference data set, wherein the noise level is one of a standard deviation, an average absolute deviation or a median absolute deviation.

4. The computer-implemented method of claim 3, wherein determining the noise level comprises determining an average moving noise level over a number of successive layers of the temperature difference data set, and generating the user alert and/or stopping the build process upon detecting that the noise level exceeds the predefined threshold, wherein the predefined threshold comprises a maximum noise level increase.

5. The computer-implemented method of claim 3, wherein the method further comprises comparing the determined noise level to the nominal noise level, and wherein the predefined threshold is based on the nominal noise level.

6. The computer-implemented method of claim 1, wherein the predefined threshold comprises a predefined temperature range of the temperature difference data set and wherein determining the level of deviation comprises identifying one or more outliers in the temperature difference data set that fall outside the predefined temperature range;
optionally wherein each outlier signifies either: a cold layer where the outlier falls below the predefined temperature range and signifies that the corresponding layer is colder than estimated, or a hot layer where the outlier lies above the predefined temperature range and signifies that the corresponding layer is hotter than estimated;
optionally wherein the user alert is generated and/or the build process is stopped upon determining that the number of outliers exceeds a predefined maximum number of outliers.

7. The computer-implemented method of claim 1, wherein the corresponding post-fuse temperature is the post-fuse temperature measured for the preceding layer, and the estimated pre-fuse temperature is provided based on the measured post-fuse temperature of the preceding layer.

8. The computer-implemented method of claim 1, wherein the obtained pre-fuse temperature is an obtained average pre-fuse temperature, wherein the obtained post-fuse temperature is an obtained average post-fuse temperature, and wherein the estimated pre-fuse temperature is an estimated average pre-fuse temperature.

9. The computer-implemented method of claim 8, wherein obtaining the average pre-fuse temperature comprises measuring or obtaining a plurality of pre-fuse temperature measurements of the layer between preheating and fusing, and calculating the average pre-fuse temperature from the plurality of pre-fuse temperature measurements; and wherein obtaining the average post-fuse temperature comprises measuring or obtaining a plurality of post-fuse temperature measurements of the layer between fusing and distributing, and calculating the average post-fuse temperature from the plurality of post-fuse temperature measurements.

10. The computer-implemented method of claim 1, wherein the predefined threshold is determined from an initial subset of the plurality of layers, wherein the initial subset precedes the subset of layers.

11. The computer-implemented method of claim 10, wherein the estimated pre-fuse temperature is calculated from a conversion model obtained from one or more obtained pre-fuse temperatures and one or more obtained post-fuse temperatures of the initial subset of layers.

12. The computer-implemented method of claim 1, wherein the predefined threshold is determined based on a nominal build process.

13. The computer-implemented method of claim 12, wherein the estimated pre-fuse temperature is calculated from a conversion model obtained from one or more obtained pre-fuse temperatures and one or more obtained post-fuse temperatures of a nominal build process.

14. The computer-implemented method of claim 1, further comprising, subsequent to determining that the level of deviation exceeds the predefined threshold, carrying out one or more verification routines and/or causing one or more maintenance routines to be carried out.

15. The computer-implemented method of claim 14, wherein the verification routine comprises retrieving recorded build process data.

16. The computer-implemented method of claim 15, wherein the level of deviation comprises the level of noise exceeding the predefined threshold, wherein the recorded build process data comprises one or more pre-fuse and/or post-fuse thermal measurements in the form of thermal images, wherein the verification routine further comprises carrying out an image analysis of successive post-fuse thermal images and/or of successive pre-fuse thermal images, and upon identifying one or more sub-areas of abnormal temperature variation within the successive post-fuse thermal images and/or of successive pre-fuse thermal images, causing the alert to be generated and/or stopping the build process.

17. The computer-implemented method of claim 16, comprising causing the build process to be paused, causing a cleaning routine to be carried out on a layer distribution subsystem configured to distribute each layer during the build process, and causing the build process to be resumed.

18. The computer-implemented method of claim 15, wherein the level of deviation comprises one or more outliers, and wherein the recorded build process data comprises position data of a vertical lift subsystem configured to lower the formed layers ahead of distributing each new layer, wherein the verification routine further comprises carrying out a comparison of the retrieved position data against an expected position data, and upon identifying that the retrieved position data identifies abnormal behaviour of the vertical lift subsystem, causing the build process to be stopped.

19. The computer-implemented method of claim 1, wherein at least one layer anomaly is detected in an object layer of the plurality of layers, wherein the object layer comprises an object cross section selectively fused within the layer;
and optionally wherein the method further comprises causing the build process to be stopped.

20. A powder bed fusion apparatus connectable to or comprising: a processor configured to execute the computer-implemented method of claim 1; and a controller configured to generate the alert and/or to stop the build process based on an output of the executed computer-implemented method as received from the processor;
optionally wherein the processor is further configured to obtain recorded build process data, analyse the recorded build process data against an expected behaviour for a successive number of layers, and optionally to cause the controller to carry out a cleaning routine on the layer distribution subsystem.
